(19) United States
(12) Patent Application Publication
(10) Pub. No.: US 2014/0215332 A1
(43) Pub. Date: Jul. 31, 2014

(54) VIRTUAL MICROPHONE SELECTION CORRESPONDING TO A SET OF AUDIO SOURCE DEVICES

(71) Applicant: HEWLETT-PACKARD DEVELOPMENT COMPANY, LP, Fort Collins, CO (US)

(72) Inventors: Bowon Lee, Palo Alto, CA (US); Ronald W. Schafer, Palo Alto, CA (US)

(73) Assignee: HEWLETT-PACKARD DEVELOPMENT COMPANY, LP, Fort Collins, CO (US)

(21) Appl. No.: 13/756,428

(22) Filed: Jan. 31, 2013

(51) Int. Cl. G06F 3/0484

(52) U.S. Cl. CPC G06F 3/0484
USPC 715/716

(57) ABSTRACT

A method performed by a processing system includes providing, to an audio service, a virtual microphone-selection corresponding to at least one of a set of audio source devices determined to be in proximity to the processing system and receiving, from the audio service, an output audio stream that is formed from one of a set of source audio streams received from the set of audio source devices and corresponds to the virtual microphone selection.

### BACKGROUND

A user of an electronic device, such as a smartphone, a tablet, a laptop, or other processing system, is often in proximity to other users of electronic devices. To allow the devices of different users to interact, a user generally enters some form of information that identifies the other users to allow information to be transmitted between devices. The information may be an email address, a telephone number, a network address, or a website, for example. Even once devices begin to interact, the ability of one user to access information, such as audio data, of another user from the device of the other user is generally very limited due to privacy and security concerns.

### BRIEF DESCRIPTION OF THE DRAWINGS

FIG. 1 is a schematic diagram illustrating an example of a processing environment with a processing system that selects an output audio stream from a set of audio source devices via an audio service.

FIG. 2 is a flow chart illustrating an example of a method for selecting an output audio stream from a set of audio source devices via an audio service.

FIG. 3 is a flow chart illustrating an example of a method for providing an output audio stream from a set of source audio streams to a device.

FIG. 4 is a block diagram illustrating an example of additional details of a processing system that implements an audio selection unit.

FIG. 5 is a block diagram illustrating an example of a processing system for implementing art audio service.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a processing system (e.g., a smartphone, tablet or laptop) selects an output audio stream from a set of audio source devices via an audio service. The audio source devices capture sounds from nearby audio sources with microphones and stream the captured audio as source audio streams. The processing system and the audio source devices register with the audio service and each provide source audio streams to the audio service. The processing system and the audio source devices allow corresponding users to provide a virtual microphone selection to the audio service to cause a selected audio stream formed from one or more of the source audio streams be received from the audio service. By doing so, the processing system and the audio source devices may selectively access audio information from other devices.

In one illustrative example, the processing system and the audio source devices may be co-located in the same meeting room or auditorium where the users of the processing system and the audio source devices have registered with an audio service. A user with a processing system in one area of the meeting room or auditorium may identify an audio source device located in another area of the meeting room, auditorium, or other large scale event that is nearer to audio content of interest (e.g., an area nearer to an active presenter at a meeting). The user provides a virtual microphones selection to the audio service in order to receive an audio stream from the audio service that is formed from a source audio stream that is captured by the audio source device nearer to audio content of interest. The user outputs the audio stream from the audio service using an internal audio output device of the processing system (e.g., speakers or headphones) or an external audio output device (e.g., a hearing aid wirelessly coupled to the processing system).

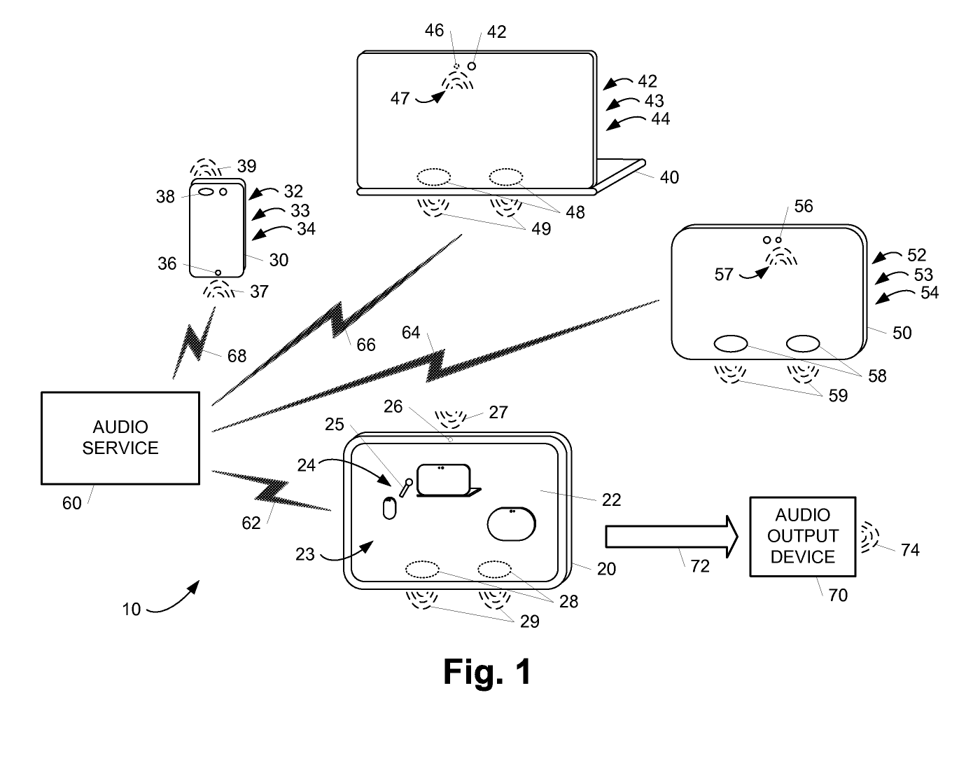

FIG. 1 is a schematic diagram illustrating en example of a processing environment 10 with a processing system 20 that selects an output audio stream from a set of audio source devices 30, 40, and 50 via an audio service 60. Processing system 20 and devices 30, 40, and 50 communicate with audio service 60 using network connections 62, 64, 66, and 68, respectively, to provide source audio streams and virtual microphone selections to audio service 60 and receive output audio streams corresponding to the virtual microphone selections from audio service 60.

The description herein will primarily describe the operation of environment 10 from the perspective of processing system 20. The functions described with reference to processing system 20 may also be performed by devices 30, 40, and 50 and other suitable devices (not shown) in other examples. As used herein, the terms processing system and device are used interchangeably such that processing system 20 may also be referred to device 20 and devices 30, 40, and 50 may also be referred to as processing systems 30, 40, and 50. In FIG. 1, processing system 20 is shown as a tablet computer, and devices 30, 40, and 50 are shown as a smartphone, a laptop, and a tablet, respectively. The type and arrangement of these devices 20, 30, 40, and 50 as shown in FIG. 1 as one example, and many other types and arrangements of devices may be used in other examples.

Each of processing system 20 and devices 30, 40, and 50 may be implemented using any suitable type of processing system with a set of one or more processors configured to execute computer-readable instructions stored in a memory system where the memory system includes any suitable type, number, and configuration of volatile or non-volatile machine-readable storage media configured to store instructions and data. Examples of machine-readable storage media in the memory system include hard disk drives, random access memory (RAM), read only memory (ROM), flash memory drives and cards, and other suitable types of magnetic and/or optical disks. The machine-readable storage media are considered to be an article of manufacture or part of an article of manufacture. An article of manufacture refers to one or more manufactured components.

Processing system 20 end devices 30, 40, and 50 include displays 22, 32, 42, and 52, respectively, for displaying user interfaces 23, 33, 43, and 53, respectively, to corresponding users. Processing system 20 and devices 30, 40, and 50 generate user interfaces 23, 33, 43, and 53, respectively, to include representations 34, 34, 44, and 54, respectively, that illustrate an arrangement of the other, proximately located processing system 20 and/or devices 30, 40, and 50. The arrangement may be based on the positions of the other processing system 20 and/or devices 30, 40, and 50 relative to a given processing system 20 and/or device 30, 40, or 50. For example, representation 24 in user interface 23 illustrates the positions of devices 30, 40, and 50, which are determined to be in proximity to processing system 20, relative to processing system 20. The arrangement may also take the form of a list or other suitable construct that identifies processing system 20 and/or devices 30, 40, and 50 and/or users of the processing system 20 and/or devices 30, 40, and 50. The arrangement may include a floor plan or room diagram indicating areas covered by one or more processing system 20 and/or devices 30, 40, and 50 without displaying the devices themselves.

Processing system 20 and devices 30, 40, and 50 also include one or more microphones 26, 36, 46, and 50, respectively, that capture audio signals 27, 37, 47, and 57, respectively. Processing system 20 and devices 30, 40, and 50 provide audio signals 27, 37, 47, and 57, respectively, and/or other source audio content, respectively, to audio service 60 as source audio streams using network connections 62, 64, 66, and 68, respectively.

Processing system 20 and devices 30, 40, and 50 further include internal audio output devices 28, 38, 48, and 58, respectively, that output audio streams received from audio service 60 as output audio signals 29, 39, 49, and 59, respectively. Internal audio output devices 28, 38, 48, and 58 may include speakers, headphones, headsets, and/or other suitable audio output equipment. Processing system 20 and devices 30, 40, and 50 may also provide output audio streams received from audio service 60 to external audio output devices. For example, processing system 20 may provide an output audio stream 72 received from audio service 60 to an external audio output device 70 via a wired or wireless connection to produce output audio signal 74. External audio output devices may include hearing aids, speaker, headphones, headsets, and/or other suitable audio output equipment.

Audio service 60 registers each of processing system 20 and devices 30, 40, and 50 to allow audio service 60 to communicate with processing system 20 and devices 30, 40, and 50. Audio service 80 may store and/or access other information concerning processing system 20 and devices 30, 40, and 50 and/or users of processing system 20 and devices 30, 40, and 50 such as user profiles, device names, device models, and Internet Protocol (IP) addresses of processing system 20 and devices 30, 40, and 50. Audio service 60 may also receive or determine information that identifies the positions of processing system 20 and devices 30, 40, and 50 relative to one another.

Network connections 62, 64, 66, and 68 each include any suitable type, number, and/or configuration of network and/or port devices or connections configured to allow processing system 20 and devices 30, 40, and 50, respectively, to communicate with audio service 60. The devices and connections 62, 64, 68, and 68 may operate according to any suitable networking and/or port protocols to allow information to be transmittal by processing system 20 and devices 30, 40, and 50 to audio service 80 and received by processing system 20 and devices 30, 40, and 50 from audio service 60.

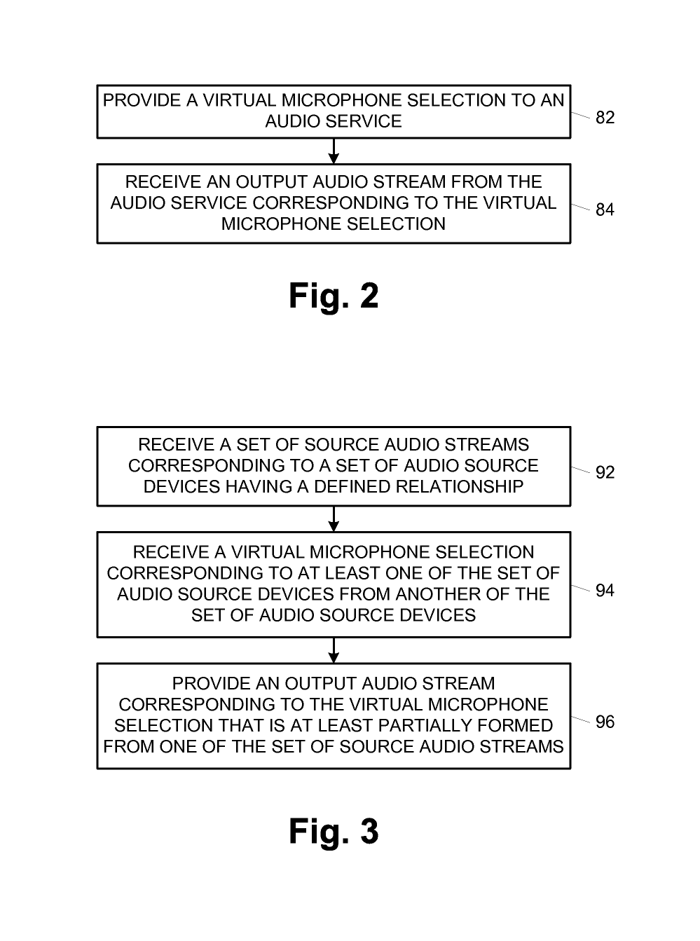

An example of the operation of processing system 20 in selecting an output audio stream from audio source devices 30, 40, and 50 via audio service 60 will now be described with reference to the method shown in FIG. 2.

In FIG. 2, processing system 20 provides a virtual microphone selection 25 to audio service 60 using network connection 62, where audio service 60 receives source audio streams from devices 30, 40, and 50, as indicated in a block 82. To obtain virtual microphone selection 25 from a user, processing system 20 generates user interface 23 to include a representation 24 of devices 30, 40, and 50 (shown in FIG. 1) determined to be in proximity to processing system 20. Either processing system 20 or audio service 60 may identify devices 30, 40, and 50 as being in proximity to processing system 20 using any suitable information provided by users and/or sensors of processing system 20 and/or devices 30, 40, and 50. Processing system 20 may generate representation 24 to include information corresponding to devices 30, 40, and 50 that is received from audio service 60 where audio service 60 obtained the information as part of the registration process. The received information may include user profiles or other information that identifies users of devices 30, 40, and 50, or device names, device models, and/or Internet Protocol (IP) addresses of devices 30, 40, and 50.

Processing system 20 identifies one or more of devices 30, 40, and 50 that correspond to virtual microphone selection 25. Virtual microphone selection 25 may, for example, identify one of devices 30, 40, or 50 where a user specifically indicates one of devices 30, 40, or 50 in representation 24 (e.g., by touching or clicking the representation of device 30, 40, or 50 in representation 24). Virtual microphone selection 25 may also identify two or more of devices 30, 40, and 50 where a user specifically indicates two or more of devices 30, 40, or 50 in representation 24. Virtual microphone selection 25 may further identify an area or a direction relative to devices 30, 40, and/or 50 in representation 24 that allows audio service 60 to select or combine source audio streams from the area or direction.

Processing system 20 receives an output audio stream from audio service 60 corresponding to virtual microphone selection 25 as indicated in a block 84. Where virtual microphone selection 25 identifies a single one of device 30, 40, or 50, the output audio stream may be formed from the source audio stream torn the identified one of device 30, 40, or 50, possibly enhanced by audio service 60 using other source audio streams. Where virtual microphone selection 25 identifies a two or more of devices 30, 40, or 50, the output audio stream maybe formed from a combination of the source audio streams from the identified device 30, 40, and/or 50, possibly further enhanced by audio service 60 using other source audio streams, e.g., via beamforming. Where virtual microphone selection 25 identifies an area or a direction relative to devices 30, 40, and/or 50, the output audio stream may be formed from one or more of the source audio streams from device 30, 40, and/or 50 corresponding to the area or direction.

As noted above, processing system 20 provides the output audio stream to an internal output, device 28 or external audio output device 70 to be played to a user.

An example of the operation of audio service 60 in providing an output audio stream from a set of source audio streams to processing system 20 will now be described with reference to the method shown in FIG. 3.

In FIG. 3, audio service 60 receives a set of source audio streams corresponding to a set of audio source devices (i.e., processing system 20 add devices 30, 40, and 50) having a defined relationship as indicated in a block 92. As noted above, audio service 60 may register processing system 20 and devices 30, 40, and 50 to allow the relationship to be defined. Audio service 60 may also receive or determine information that identifies the positions of processing system 20 end devices 30, 40, and 50 relative to one another.

Audio service 60 receives a virtual microphone selection corresponding to at least one of the set of audio source devices from another of the set of audio source devices as indicated in a block 94. Audio service 60 provides an output audio stream corresponding to the virtual microphone selection that is at least partially termed from one of the set of source audio streams as indicated in a block 96.

For each virtual microphone selection received froth processing system 20 and devices 30, 40, and 50, audio service 60 may form an output audio stream from one or more of the set of source audio streams.

When a virtual microphone selection identifies a single one of processing system 20 or device 30, 40, or 50, audio service 60 may form the output audio stream from the source audio stream from the identified one of processing system 20 or device 30, 40, or 50. When virtual microphone selection 25 identifies a two or more of devices 30, 40, or 50, audio service 60 may form the output audio stream by mixing a combination of the source audio streams from the identified ones of processing system 20 and/or device 30, 40, and/or 50. When virtual microphone selection 25 identifies an area or a direction relative to devices 30, 40, and/or 50, audio service 60 may identify one or more of processing system 20 and/or device 30, 40, and/or 50 that correspond to the area or the direction and form the output audio stream from the source audio streams of the identified ones of processing system 20 and/or device 30, 40, and/or 50. In each of the above examples, audio service 60 may enhance the output audio streams by using additional source audio streams (i.e., ones that do not correspond to virtual microphone selection) or by using audio techniques such as beamforming, acoustic echo cancellation, and/or denoising.

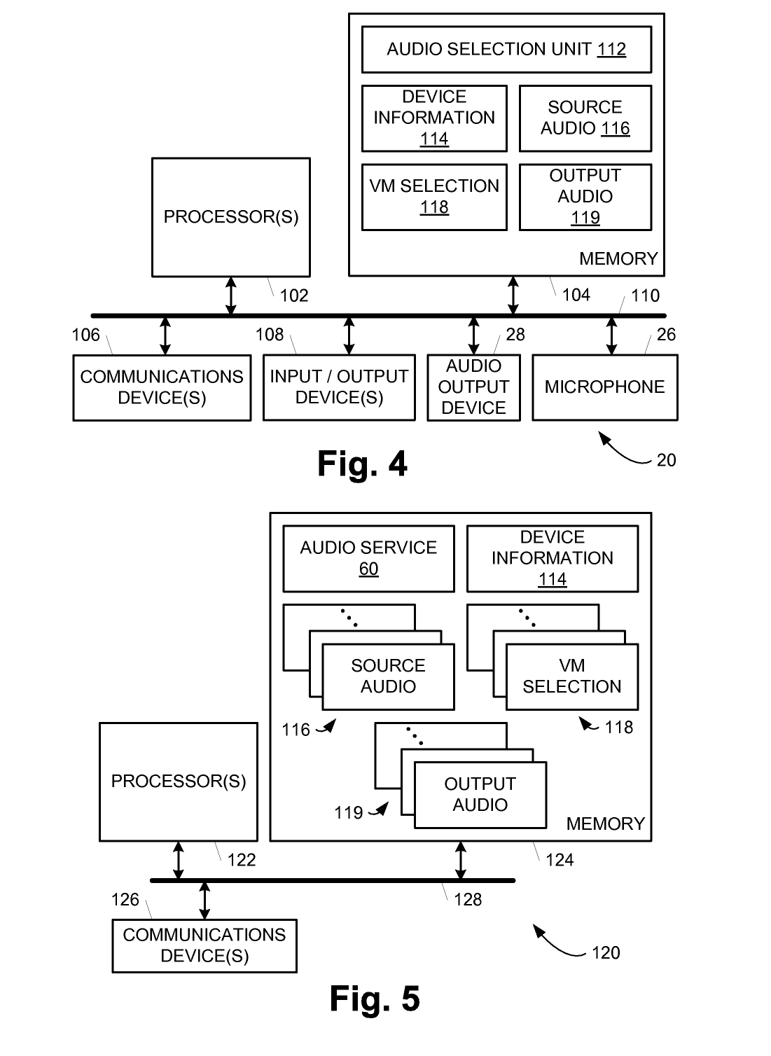

FIG. 4 is a block diagram illustrating an example of additional details of processing system 20 where processing system 20 implement an audio selection unit 112 to perform the functions described above. In addition to microphone 26 and audio output device 28, processing system 20 includes a set of one or more processors 102 configured to execute a set of instructions stored in a memory system 104, at least one communications device 106, and at least one input/output device 108. Processors 102, memory system 104, communications devices 106, and input/output devices 108 communicate using a set of interconnections 110 that includes any suitable type, number, and/or configuration of controllers, buses, interfaces, and/or other wired or wireless connections.

Each processor 102 is configured to access and execute instructions stored in memory system 104 and to access and store data in memory system 104. Memory system 104 includes any suitable type, number, and configuration of volatile or non-volatile machine-readable storage-media configured to store instructions and data. Examples of machine-readable storage media in memory system 104 include hard disk drives, random access memory (RAM), read only memory (ROM), flash memory drives and cards, and other suitable types of magnetic and/or optical disks. The machine-readable storage media are considered to be part of an article or article of manufacture. An article or article of manufacture refers to one or more manufactured components.

Memory system 104 stores audio selection unit 112, device information 114 received: from audio service 60 for generating representation 24, source audio stream 118 (e.g., an audio stream captured using microphone 26 or other source audio content), a virtual microphone selection 118 (e.g., virtual microphone selection 25 shown in FIG. 1), and an output audio stream 119 received from audio service 60 and corresponding to virtual microphone selection 118. Audio selection unit 112 includes instructions that, when executed by processors 102, causes processors 102 to perform the functions described above.

Communications devices 108 include any suitable type, number, and/or configuration of communication's devices configured to allow processing system 20 to communicate across one or more wired or wireless networks.

Input/output devices 108 include any suitable type, number, and/or configuration of input/output devices configured to allow a user to provide information to and receive information from processing system 20 (e.g., a touchscreen, a touchpad, a mouse, buttons, switches, and a keyboard).

FIG. 5 is a block diagram illustrating an example of a processing system 120 for implementing audio service 60. Processing system 120 includes a set of one or more processors 122 configured to execute a set of instructions stored in a memory system 124, and at least one communications device 126. Processors 122, memory system 124, and communications devices 126 communicate using a set of interconnections 128 that includes any suitable type, number, and/or configuration of controllers, buses, interfaces, and/or other wired or wireless connections.

Each processor 122 is configured to access and execute instructions stored in memory system 124 and to access and store data in memory system 124. Memory system 124 includes any suitable type, number, and configuration of volatile or non-volatile machine-readable storage media configured to store instructions and data. Examples of machine-readable storage media in memory system 124 include hard disk drives, random access memory (RAM), read only memory (ROM), flash memory drives and cards, and other suitable types of magnetic and/or optical disks. The machine-readable storage media, are considered to be part of an article or article of manufacture. An article or article of manufacture refers to one or more manufactured components.

Memory system 124 stores audio service 60, device information 114 for processing system 20 and devices 30, 40, and 50, source audio streams 116 received from processing system 20 and devices 30, 40, and 50, virtual microphone selections 118 received from processing system 20 and devices 30, 40, and 50, and output audio streams 119 corresponding to virtual microphone selections 118. Audio service 50 includes instructions that, when executed by processors 122, causes processors 122 to perform functions described above.

Communications devices 126 include any suitable type, number, and/or configuration of communications devices configured to allow processing system 120 to communicate across one or more wired, or wireless networks.

What is claimed is:

1. A method performed by a processing system, the method comprising:
providing, to an audio service, a virtual microphone selection corresponding to a first one of a set of audio source devices determined to be in proximity to the processing system, the virtual microphone selection entered via a user interface that includes, a representation of the set of audio source devices; and
receiving, from the audio service, an output audio stream that is formed from a first one of a set of source audio streams received from the set of audio source devices and corresponds to the virtual microphone selection.

2. The method of claim 1 wherein the representation in the user interface illustrates an arrangement of the set of audio source devices.

3. The method of claim 2 wherein the arrangement is based on the positions of the set of audio source devices relative to the processing system.

4. The method of claim 1 wherein the virtual microphone selection corresponds to the first one of the set of audio source devices in the representation, and wherein the first one of the set of source audio streams is received by the audio service from the first one of the set of audio source devices.

5. The method of claim 4 wherein the virtual microphone, selection corresponds to the first one and a second one of the set of audio source devices in the representation, wherein a second one of the set of source audio streams is received by the audio service from the second one of the set of audio source devices, and wherein the output audio stream is formed from the first and the second ones of the set of source audio streams.

6. The method of claim 1 further comprising:
outputting the output audio stream with an internal audio output device of the processing system.

7. The method of claim 1 further comprising:
providing the output audio stream from the processing system to an external audio output device.

8. The method of claim 1 further comprising:
providing a local audio stream from the processing system to the audio service.

9. An article comprising at least one machine readable storage medium storing instructions that, when executed by a processing system, cause the processing system to:
receive a set of source audio streams corresponding to a set of audio source devices having a defined relationship;
receive a first virtual microphone selection corresponding to a first one of the set of audio scarce devices from a second one of the set of audio source devices; and
provide, to the second one of the set of audio source devices, a first output audio stream that is at least partially formed from a first one of the set of source audio streams received from the first one of the set of audio source devices.

10. The article of claim 9, wherein the first virtual microphone selection corresponds to the first one of the set of audio source devices and a third one of the set of audio source devices, and wherein the first output audio stream is at least partially formed from the first one of the set of source audio streams and a third one of the set of source audio streams received from the third one of the set of audio source devices.

11. The article of claim 10, wherein the instructions, when executed by the processing system, cause the processing system to:
generate the first output audio stream from the first one of the set of source audio streams and the third one of the set of source audio streams based on the positions of the first and the third ones of the set of audio source devices relative to the second one of the set of audio source devices.

12. The article of claim wherein the instructions, when executed by the processing system, cause the processing system to:
receive a second virtual microphone selection corresponding to a third one of the set of a audio source devices from a fourth one of the set of audio source devices; end
provide, to the third one of the set of audio source devices, a second output audio stream that is at least partially formed from a second one of the set of source audio streams received from the fourth one of the set of audio source devices.

13. A method performed by a processing system, the method comprising:
generating a user interlace that includes a representation of a set of audio source devices determined to be in proximity to the processing system;
receiving a virtual microphone selection corresponding to a first one of the set of audio source devices in the representation via the user interface;
providing the virtual microphone selection to an audio service that receives a set of source audio streams from the set of audio source devices; and
receiving, from the audio service, an output audio stream that corresponds to the virtual microphone selection and is formed from at least a one of the set of source audio streams received by the audio service from the first one of the set of audio source devices.

14. The method of claim 13 further comprising:
providing the output audio stream from the processing system to one of an internal audio output device or an eternal audio output device.

15. The method of claim 13 further comprising:
capturing a local audio stream using a microphone of the processing system; and
providing the local audio stream from the processing system to the audio service.
